(19) United States
(12) Patent Application Publication
(10) Pub. No.: US 2013/0117757 A1
(43) Pub. Date: May 9, 2013

(54) METHOD AND APPARATUS FOR SCHEDULING APPLICATION PROGRAMS

(71) Applicant: Electronics and telecommunications research insti, Daejeon (KR)

(72) Inventor: Yung Joon JUNG, Daejeon (KR)

(73) Assignee: ELECTRONICS AND TELECOMMUNICATIONS RESEARCH INSTITUTE, Daejeon (KR)

(21) Appl. No.: 13/657,237

(22) Filed: Oct. 22, 2012

(30) Foreign Application Priority Data
Nov. 9, 2011 (KR) 10-20110116219

(51) Int. Cl. G06F 9/46; G06F 9/50

(52) U.S. Cl. 718/103; 718/102

(57) ABSTRACT

A method for scheduling an application includes receiving an execution command of at least one application; and receiving task characteristic information of I/O-BOUND and CPU-BOUND for the at least one application. Further, the method for scheduling the application includes performing scheduling for the at least one application by applying the task characteristic information.

### CROSS-REFERENCE TO RELATED APPLICATIONS

The present invention claims priority of Korean Patent Application No. 10-2011-0116219, filed on Nov. 9, 2011, which is incorporated herein by reference.

### FIELD OF THE INVENTION

The present invention relates to a scheduling through an operating system of a hardware; and more particularly, to a method and an apparatus for scheduling application programs, suitable for performing scheduling of resources of a central processing unit (CPU) using priority and time slice based on task characteristic information that is inputted to a scheduler of the operating system.

### BACKGROUND OF THE INVENTION

Recently, hardware is developing more and more thanks to technical advances of technology of very high degree integration, assembling technology, and cooling technology, and due to this an operating system capable of performing various tasks is being loaded in at least a single hardware. In this case, the operating system serves to perform and manage a plurality of applications (tasks) and performance may differ in accordance with the performance and management politics for the applications.

An important factor causing the performance difference in the operating system is very scheduling by a scheduler. The scheduling technique means the highest performance of tasks that are assumed as a unit in which an application is actually driven, wherein, in view of the operating system, the scheduling technique allows CPU resources to be used by allocating the same by a time unit as restricted resources in the situation where tasks in the level of a system and other various application tasks are driven at the same time.

When tasks are scheduled by a scheduler in a usual operating system, important factors are priority and time slice, wherein the scheduler finds out a task remaining time slice (CPU-using time remaining in every task) and having the highest priority from tasks capable of being scheduled and allocates CPU to the found task first.

As such, time slice of a corresponding task is decreased as much as being executed when a specific task allocated with CPU and executed, and the scheduler repeats the procedure of stopping the executing task and of finding out and executing a task with the highest priority from the remaining tasks when all time slices are exhausted or when a task with more high priority is generated due to various reasons.

Though there are many ways in this scheduling technique, unsolved one of them is that the operating system itself determines whether a task is a CPU-BOUND task or an I/O-BOUND task to apply the determination to the scheduling.

Here, the CPU-BOUND means a status in which an executing computing task is determined by speed of CPU and the I/O-BOUND means a status in which the executing computing task is determined by input and output time of data and may by occurred when data request time is longer than processing time.

Thus, most of time is spent for sending and waiting for request for input and output in CPU scheduling and the I/O-BOUND with a short CPU using time may have higher priority than the CPU-BOUND.

When the operating system can distinguish tasks into the CPU-BOUND and the I/O-BOUND clearly, this may be helpful to the scheduling and bring performance improvement of the system in which the operating system is loaded. In general, the I/O-BOUND task is an event-processing task of processing file system I/O and device I/O mainly and works holding the CPU for a short time so that the time slice may be short and the priority may be high and on the contrary, the CPU-BOUND task mainly performs calculations such as calculations of mathematic equations and graphic calculations for a long time so that the time slice may be long and the priority may be low such that performance can be improved by cache function using the CPU for a long time when the CPU is held once.

However, it is not easy to distinguish the tasks performed in the operating system into the I/O-BOUND tasks and the CPU-BOUND tasks clearly. This is because, since there are tasks belonging to the I/O BOUND tasks like an editor but there may be a task of performing editing and calculation simultaneously, the operating system cannot easily distinguish the tasks in view of characteristics and have a difficulty to apply characteristics of the tasks to the scheduling technique.

Since the operating system itself determines whether a task is a CPU-BOUND task or an I/O-BOUND task and applies the determination to the scheduling in the existing scheduling of an existing operating system as described above, the determination is not easily made when characteristic of a corresponding task is ambiguous and in addition overall deterioration of system performance may be occurred when the determination is wrong.

### SUMMARY OF THE INVENTION

In view of the above, the present invention provides application scheduling method and apparatus for performing CPU scheduling using priority and time slice based on task characteristic information that is inputted into a scheduler of an operating system.

Moreover, the present invention provides application scheduling method and apparatus for performing scheduling of CPU resources by checking whether CPU-BOUND characteristic information and an I/O-BOUND characteristic information of a corresponding task are inputted when a task executing command for a specific application has been inputted from a scheduler of an operating system and by using priority and time slice based on the inputted task characteristic information.

In accordance with a first aspect of the present invention, there is provided a method for scheduling an application including: receiving an execution command of at least one application; receiving task characteristic information of I/O-BOUND and CPU-BOUND for the at least one application; and performing scheduling for the at least one application by applying the task characteristic information.

In accordance with a second aspect of the present invention, there is provided an apparatus for scheduling an application including: an input unit receiving an execution command of at least one application and task characteristic information of I/O-BOUND and CPU-BOUND for the at least one application; a scheduler performing scheduling for the at least one application by applying the task characteristic information; and a task controller controlling the execution of the at least one task under control of the scheduler.

The application scheduling method and apparatus of the present invention are advantageous as follows:

In accordance with the present invention, the operating system itself recognizes characteristics of a task and solves a problem in which optimal scheduling may not be achieved through an input of characteristic information the task.

That is, the operating system may recognize the task characteristics inputted by a user and perform user input-based optimal scheduling establishing high performance system such that the operating system properly utilizes time slice and priority as major scheduling factors to obtain benefit in performance during the scheduling of the tasks.

Although an application developer or a user knows the characteristic of a task briefly but precise input, the system performance may be improved based on the improved scheduling factor by changing input of the task characteristic.

### BRIEF DESCRIPTION OF THE DRAWINGS

The objects and features of the present invention will become apparent from the following description of embodiments given in conjunction with the accompanying drawings, in which:

FIG. 1 is a block diagram illustrating an apparatus for scheduling an application in accordance with an embodiment of the present invention;

FIG. 2 is a flow chart illustrating optimal scheduling procedure of the apparatus for scheduling an application in accordance with the embodiment of the present invention; and

FIG. 3 is a flow chart illustrating an applying procedure of task characteristic caused by an event in accordance with the embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

A method and an apparatus for scheduling an application in accordance with an embodiment of the present invention perform CPU scheduling utilizing priority and tile slice based on task characteristics inputted into a scheduler of an operating system, wherein the method and apparatus check whether characteristic information of a CPU-BOUND task and an I/O-BOUND task with respect to a task is inputted, when a command of executing the corresponding task for a specific application is inputted from the scheduler of the operating system, and performs the scheduling of CPU resources utilizing priority and time slice based on the inputted characteristic information of the corresponding task.

Hereinafter, embodiments of the present invention will be described in detail with reference to the accompanying drawings which form a part hereof.

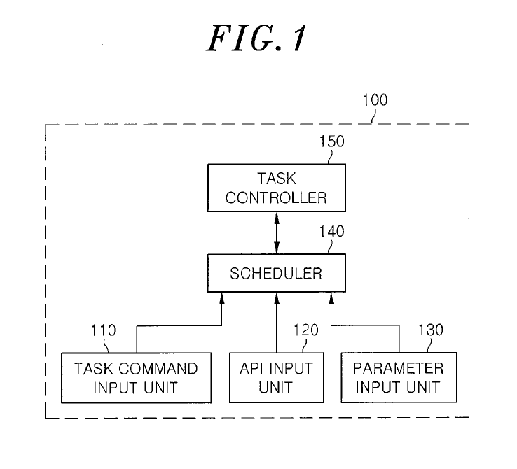

FIG. 1 is a block diagram illustrating an apparatus for scheduling an application in accordance with an embodiment of the present invention.

Referring to FIG. 1, an application scheduling apparatus 100 may include at least one hardware and an operating system installed in the hardware. The apparatus 100 may also include a task command input unit 110, an API input unit 120, a parameter input unit 130, a scheduler 140, and a task controller 150.

These elements are made of hardware, respectively but may be software divided into functional blocks in the operating system.

Specifically, the task command input unit 110 creates an executing command for a corresponding task of a specific application and transfer the same to the scheduler 140 when a user inputs an executing command to an input device such as a mouse or a keyboard that is connected to the application scheduling apparatus 100 for the executing of the specific application.

The API input unit 120 allows an application developer to understand characteristic of an application and to receive API from the operating system and to input the task characteristic of an I/O-BOUND and a CPU-BOUND to the application. Then the API input unit 120 may transfer characteristic information of the I/O-BOUND task and the CPU-BOUND task to the scheduler 140. As such, the API input unit 120 may allow the application developer to receive an I/O_BOUND_FACTOR and a CPU_BOUND_FACTOR through an interface provided by the operating system such that the operating system recognizes the factors.

The parameter input unit 130 may input values of the I/O-BOUND and the CPU-BOUND as parameter values respectively when a user executes an application. That is, when a user executes an application, a parameter for the corresponding application may be inputted before and after the execution. By doing so, the application scheduling apparatus 100 may provide a parameter input screen through a display (not shown) to a user such that the user may perform an input during the execution of an application.

As such, the parameter input unit 130 may allow a user to carry out a task and at the same time may receive the I/O_BOUND_FACTOR and the CPU_BOUND_FACTOR through parameters such that the operating system recognizes the factors.

The scheduler 140 executes and manages a plurality of applications, wherein the scheduler 140 executes a corresponding task when a command of executing a task is received from the task command input unit 110 while performing scheduling of the corresponding task based on a preset politics for execution and management. That is, the scheduling may be carried out such that a task having remaining time slice as a remaining CPU using time for every task and the highest priority is found out from applications (tasks) to be scheduled and that the CPU is allocated thereto first.

The scheduler 140, for performing the scheduling, may perform the scheduling based on characteristic information of a CPU-BOUND task and an I/O-BOUND task when the characteristic information of a CPU-BOUND task and an I/O-BOUND task on the corresponding task is received from the parameter input unit 130 and the API input unit 120.

As described above, the scheduler 140 may be transferred with an I/O BOUND FACTOR and a CPU_BOUND_FACTOR as the characteristic information of the CPU-BOUND task and the I/O-BOUND task from the parameter input unit 130 and/or the API input unit 120 and may apply the transferred factors to the preset politics for execution and management to perform the scheduling.

Meanwhile, the preset politics for execution and management may be applied as follows:

time slice

time_slice=time_slice+(time_slice*CPU_BOUND_FACTOR*OS_adaptation_factor)−(time_slice*IO_BOUND_FACTOR*OS_adaptation_factor)

priority

priority=priority+(priority*IO_BOUND_FACTOR*OS_adaptation_factor)−(priority*CPU_BOUND_FACTOR*OS_adaptation_factor)

where, time_slice is the time slice, priority is the priority, and I/O_BOUND_FACTOR and CPU_BOUND_FACTOR are parts into which a user or an application developer may insert characteristics of the I/O-BOUND task and the CPU-BOUND task.

The time slice adds a value of the CPU_BOUND_FACTOR to a basic value of a time slice of a tasks proportionally to be higher value of the time slice (and lowers the value of the time slice proportionally in accordance with a value of I/O_BOUND_FACTOR), and similarly a value of the priority may be a higher value of the priority by adding a value of the I/O_BOUND_FACTOR to a basic value of the priority proportionally (and is lowered proportionally according the value of the CPU_BOUND_FACTOR). Likely, OS_Adaptation_Factor is the same as described above.

In this case, since the operating adaptation factor OS_Adaptation_Factor included in the time slice and the priority has different a value scale of the time slice used by every operating system, the value scale of the time slice may be scaled such that an OS developer may properly apply the OS_Adaptation_Factor.

As described above, the scheduler 140 may calculate weight based on increases of statics and processing times and an accumulated occupying time of CPU based on the calculated weight, and by doing so may improve responsibility and performance in the competition situation occurring between a plurality processors.

The task controller 150 may be allocated with CPU based on the scheduling information transferred from the scheduler 140 and may execute a task.

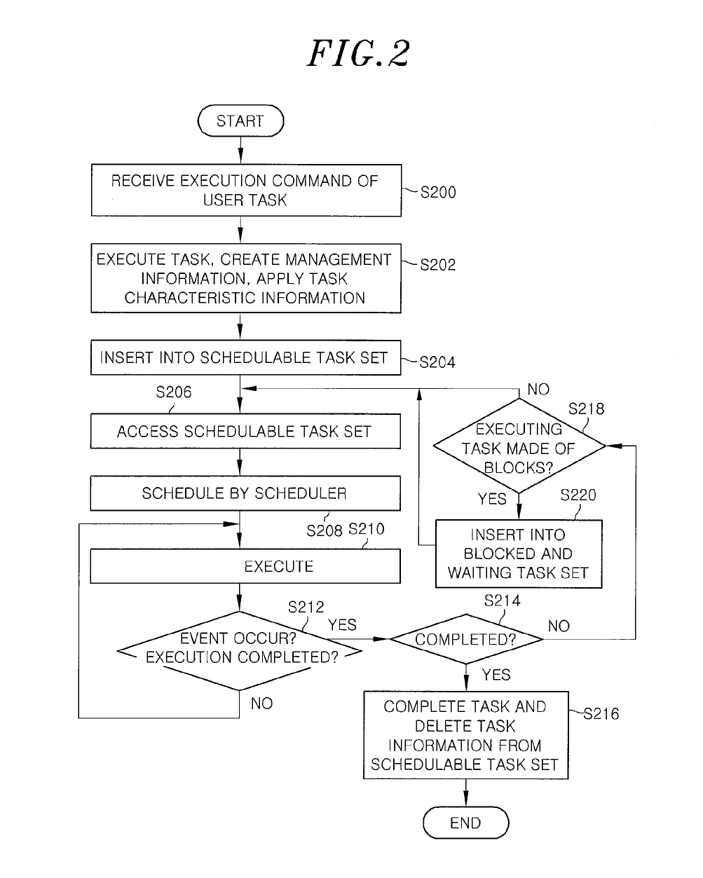

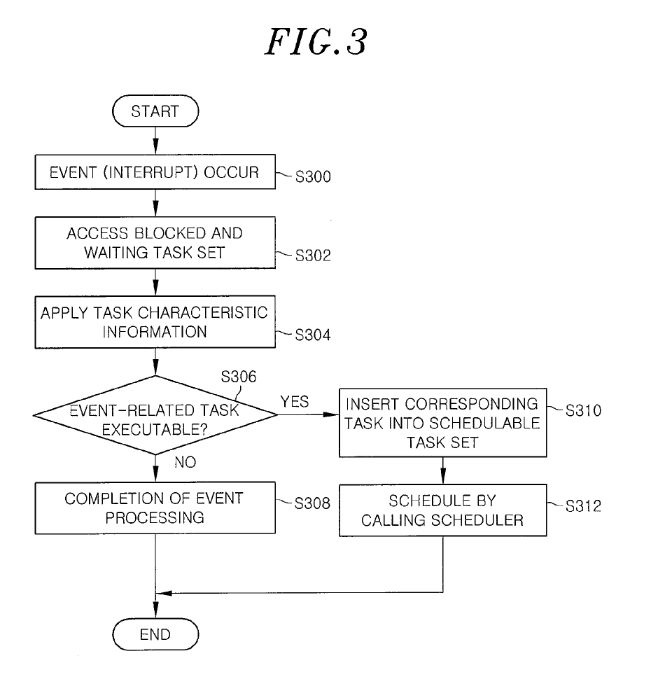

Operations using the scheduler 140 of the operating system will be described in detail with reference to FIGS. 2 and 3.

FIG. 2 is a flow chart illustrating optimal scheduling procedure of the apparatus for scheduling an application in accordance with the embodiment of the present invention.

Referring to FIG. 2, when a user inputs a command of executing an application to the task command input unit 110 during the driving of the operating system of the application scheduling apparatus 100, the scheduler 140 receives a command of executing a task from the task command input unit 120 in step S200. At this time, the API input unit 120 or the parameter input unit 130 receive the I/O_BOUND_FACTOR and CPU_BOUND_FACTOR as the characteristic information of the I/O-BOUND and the CPU-BOUND, respectively.

The respective inputted values can be expressed by real numbers between 0 (zero) to 1, wherein 1 indicates a very strong characteristic and 0 (zero) indicates there is not a characteristic at all.

In step S202, the scheduler 140 is transferred with values of the I/O_BOUND_FACTOR and the CPU_BOUND_FACTOR and applies the transferred characteristic information of the task to the values of the time slice and the priority when creating information for execution and management of a corresponding task.

In step S204, the scheduler 140 inserts information of the corresponding task, to which characteristic of a user input-based task is already applied, into a schedulable task set and waits for scheduling. Then, the scheduler 140 checks whether there is an executable task remaining time slice from schedulable task sets in step S206 and selects a task with the highest priority to perform CPU allocation in step S208.

In step S210, when the corresponding task is scheduled, the scheduler 140 executes the scheduling of the corresponding task through the controller 150 by being allocated with CPU until the execution of the corresponding task is completed or a specific event occurs. After that, the scheduler 140 determines whether an event of the corresponding task occurs or the execution of the event of the corresponding task is completed in step S212, wherein the scheduler 140 determines the execution of the corresponding task is completed when the execution of the event of the corresponding task is completed and deletes information of the corresponding task from the schedulable task set for the completion of the scheduling in step S216, or returns to step S206 to perform the scheduling of another task set.

However, when the scheduling is not finished but a new event occurs in step S214, for example when the corresponding task reads file information from a file system, it is assumed that an event of reading information from the file system occurs during the execution. Since the task is not completed, the step S218 is performed to determine whether the executing task has blocks.

When the executing task has not block, the task scheduling keeps going but the executing task is made of blocks because it takes a long time in view of hardware until reading file information from the file system, and if the corresponding task has have blocks step S220 is performed to insert the executing corresponding task into a waiting task set. The scheduler 140 returns to step S206 in order to execute another task, accesses another schedulable task set, and executes another task through scheduling.

FIG. 3 is a flow chart illustrating an applying procedure of task characteristic caused by an event in accordance with the embodiment of the present invention.

Referring to FIG. 3, the scheduler 140 checks up occurring of an event (interrupt) through an executing task in step S300. This may be occurrence of the event which needs to read information from the file system during the execution of a task as a corresponding task reads the file information from the file system.

Thus, since the corresponding task needs to wait for reading the file information from the file system, the corresponding task may not be inserted into the schedulable task set while maintaining time slice but has blocks.

Even when the corresponding task remains in the waiting task set, time still goes, another task is executed.

Therefore, the corresponding task needs to be immediately executed when the corresponding task is ready to be executed by increasing priority of the corresponding task.

To this end, in step S302, the scheduler 140 accesses the blocked and waiting task set and, in step S304, in order to prevent loss of performance while recognizing characteristics of the corresponding task by increasing the priority as high as CPU may not be used as time goes by due to a timer interrupt, characteristic of the corresponding task is applied to the priority by the timer interrupt or a user defined event if necessary as follows:

priority:

priority=priority+(priority*IO_BOUND_FACTOR*OS_adaptation_factor)−(priority*CPU_BOUND_FACTOR*OS_adaptation_factor)

However, there is no need to increase the time slice because the time slice has deep relationship with input and output (I/O) when the corresponding task is made of blocks.

Thus, when the scheduler 140 determines whether a task related to an event is executed for a preset time in step S306 and when the scheduler 140 determines preparation for the execution of the task is not completed until the preset time is expired, the scheduler 140 treats the event as if being completed in step S308.

However, if the task related an event is executable, the scheduler 140 inserts the corresponding task into the schedulable task set in step S310 and confirms the executable task remaining time slice from the schedulable task set to perform the scheduling in step S312.

As described above, the method of and the apparatus for scheduling an application in accordance with the present invention perform CPU scheduling utilizing the priority and the time slice based on the characteristic information of tasks that is inputted to the scheduler of the operating system, check whether the characteristic information of the CPU-BOUND task and the I/O-BOUND task for the corresponding task is inputted and perform the scheduling of CPU resources utilizing the priority and the time slice based on the inputted characteristic information of the task.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for scheduling an application comprising:
receiving an execution command of at least one application;
receiving task characteristic information of I/O-BOUND and CPU-BOUND for the at least one application; and
performing scheduling for the at least one application by applying the task characteristic information.

2. The method of claim 1, wherein said receiving task characteristic information is performed such that values of parameter factors of the I/O-BOUND and the CPU-BOUND are received.

3. The method of claim 1, wherein said receiving task characteristic information is performed such that factor values of the I/O-BOUND and the CPU-BOUND through an application programming interface (API) of an operating system are received.

4. The method of claim 1, wherein said performing scheduling is performed such that a task to which the task characteristic information is applied is inserted into a schedulable task set and CPU resources are allocated by scheduling the task based on time slice and priority.

5. The method of claim 1, wherein said performing scheduling comprises:
proportionally adding a factor value of the CPU-BOUND to a basic value of the time slice of the task; and
proportionally subtracting a factor value of the I/O-BOUND from a basic value of time slice.

6. The method of claim 1, wherein said performing scheduling further comprises:
proportionally adding a factor value of the I/O-BOUND to a basic value of priority of the task; and
proportionally subtracting a factor value of the CPU-BOUND from the basic value of priority.

7. The method of claim 1, wherein said performing scheduling further comprises:
inserting a task made of blocks when an event or an interrupt occurs into a waiting task set; and
accessing a schedulable task set to perform another task.

8. The method of claim 1, wherein said performing scheduling further comprises:
applying the task characteristic information to the task made of blocks when an event or an interrupt included in a waiting task set occurs; and
performing the scheduling by inserting the task to which the task characteristic information is applied into a schedulable task set.

9. The method of claim 8, wherein said applying the task characteristic information comprises:
proportionally adding a factor value of the I/O-BOUND to a basic value of priority without change of a basic value of time slice of the task; and
proportionally subtracting a factor value of the CPU-BOUND from a basic value of priority.

10. The method of claim 1, wherein the task characteristic information comprises an operating system adaption factor value of scaling a value of time slice by every operating system.

11. An apparatus for scheduling an application comprising:
an input unit receiving an execution command of at least one application and task characteristic information of I/O-BOUND and CPU-BOUND for the at least one application;
a scheduler performing scheduling for the at least one application by applying the task characteristic information; and
a task controller controlling the execution of the at least one task under control of the scheduler.

12. The apparatus of claim 11, wherein the input unit comprises a parameter input unit receiving values of parameter factors of the I/O-BOUND and the CPU-BOUND.

13. The apparatus of claim 11, wherein the input unit further comprises an API input unit receiving factor values of the I/O-BOUND and the CPU-BOUND through an application programming interface (API) of an operating system.

14. The apparatus of claim 11, wherein the scheduler inserts a task to which the task characteristic information is applied into a schedulable task set and allocates CPU resources by scheduling the task based on time slice and priority.

15. The apparatus of claim 11, wherein the scheduler:
proportionally adds a factor value of the CPU-BOUND to a basic value of the time slice of the task; and
proportionally subtracts a factor value of the I/O-BOUND from a basic value of time slice.

16. The apparatus of claim 11, wherein the scheduler:
proportionally adds a factor value of the I/O-BOUND to a basic value of priority of the task; and
proportionally subtracts a factor value of the CPU-BOUND from the basic value of priority.

17. The apparatus of claim 11, wherein the scheduler inserts a task made of blocks when an event or an interrupt occurs into a waiting task set, and accesses a schedulable task set to perform another task.

18. The apparatus of claim 11, wherein the scheduler applies the task characteristic information to the task made of blocks when an event or an interrupt included in a waiting task set occurs, and performs the scheduling by inserting the task to which the task characteristic information is applied into a schedulable task set.

19. The apparatus of claim 18, wherein the task characteristic information is processed by:
proportionally adding a factor value of the I/O-BOUND to a basic value of priority without change of a basic value of time slice of the task; and
proportionally subtracting a factor value of the CPU-BOUND from a basic value of priority.

20. The apparatus of claim 11, wherein the task characteristic information comprises an operating system adaption factor value of scaling a value of time slice by every operating system.
